(19) United States
(12) Patent Application Publication
(10) Pub. No.: US 2026/0062614 A1
(43) Pub. Date: Mar. 5, 2026

(54) ETCHING AGENT, ETCHING METHOD, AND METHOD FOR PRODUCING DEVICE

(71) Applicant: SEIKO EPSON CORPORATION, Tokyo (JP)

(72) Inventors: Shinichi YOTSUYA, CHINO-SHI (JP); Masahiro FUJII, SHIOJIRI-SHI (JP); Koji KITAHARA, INA-SHI (JP)

(73) Assignee: SEIKO EPSON CORPORATION, Tokyo (JP)

(21) Appl. No.: 19/309,636

(22) Filed: Aug. 26, 2025

(30) Foreign Application Priority Data
Aug. 28, 2024 (JP) 2024-146420

(51) Int. Cl. C09K 13/08; H01L 21/306; H01L 21/308

(52) U.S. Cl. CPC C09K 13/08

(57) ABSTRACT

According to the disclosure, provided is an etching agent for etching a semiconductor substrate having a surface partially covered with a noble metal, the etching agent including: an oxidizing agent; hydrogen fluoride; and ammonium fluoride. 0.5≤n/m≤5.0 is satisfied, where m is a molar concentration [mol/L] of the hydrogen fluoride, and n is a molar concentration [mol/L] of the ammonium fluoride.

The present application is based on, and claims priority from JP Application Serial Number 2024-146420, filed Aug. 28, 2024, the disclosure of which is hereby incorporated by reference herein in its entirety.

### BACKGROUND

### 1. Technical Field

The present disclosure relates to an etching agent, an etching method, and a method for producing a device.

### 2. Related Art

JP-A-2017-050378 discloses an etching method in which an etching agent containing hydrogen fluoride acid, an oxidizing agent, and a buffering agent is supplied to a semiconductor substrate having a first region covered with a metal layer made of one or more metals other than noble metals such as aluminum and a second region covered with a catalyst layer made of noble metals, and etching of the semiconductor substrate is caused at a position of the catalyst layer. According to such a configuration, when the semiconductor substrate provided with the metal layer is etched by a metal-assisted chemical etching method, the semiconductor can be etched at a high selectivity.

JP-A-2017-050378 is an example of the related art.

In the metal-assisted chemical etching method as described in JP-A-2017-050378, when a recess is formed in a workpiece, smoothness of a bottom surface of the recess cannot be sufficiently enhanced.

Therefore, an object is to implement an etching agent and an etching method capable of forming a recess having a smooth bottom surface by a metal-assisted chemical etching method.

### SUMMARY

An etching agent according to an application example of the present disclosure is an etching agent for etching a semiconductor substrate having a surface partially covered with a noble metal, the etching agent includes:
an oxidizing agent;
hydrogen fluoride; and
ammonium fluoride,
0.5≤n/m≤5.0, where
m is a molar concentration [mol/L] of the hydrogen fluoride, and
n is a molar concentration [mol/L] of the ammonium fluoride.

An etching method according to an application example of the present disclosure is an etching method for etching the semiconductor substrate, including:
preparing the semiconductor substrate having, on the surface, a first region in which a noble metal is exposed and a second region in which the noble metal is not exposed; and
supplying the etching agent according to the application example of the present disclosure to the surface of the semiconductor substrate to etch the semiconductor substrate.

A method for producing a device according to an application example of the present disclosure is a method for producing a device including a processed semiconductor substrate, the method including:
forming a recess in the surface of the semiconductor substrate by the etching method according to the application example of the present disclosure to acquire the processed semiconductor substrate; and
producing the device using the processed semiconductor substrate.

### BRIEF DESCRIPTION OF THE DRAWINGS

FIG. 1 is a process diagram showing a configuration of a method for producing a device according to an embodiment.

FIG. 2 is a cross-sectional view illustrating the method for producing the device shown in FIG. 1.

FIG. 3 is a cross-sectional view showing the method for producing the device shown in FIG. 1.

FIG. 4 is a cross-sectional view illustrating the method for producing the device shown in FIG. 1.

FIG. 5 is a cross-sectional view illustrating the method for producing the device shown in FIG. 1.

FIG. 6 is a cross-sectional view illustrating the method for producing the device shown in FIG. 1.

FIG. 7 is a cross-sectional view illustrating the method for producing the device shown in FIG. 1.

FIG. 8 is a cross-sectional view illustrating the method for producing the device shown in FIG. 1.

FIG. 9 is a cross-sectional view illustrating the method for producing the device shown in FIG. 1.

FIG. 10 is Table 1 showing preparation conditions and evaluation results of evaluation samples obtained in Examples 1 and 2.

FIG. 11 is Table 2 showing the preparation conditions and the evaluation results of the evaluation samples obtained in Examples 2 and 3.

FIG. 12 is Table 3 showing the preparation conditions and the evaluation results of the evaluation samples obtained in Comparative Example 1 and Comparative Example 2.

FIG. 13 is a graph showing a relationship between a molar concentration ratio n/m of an etching agent and an etching rate.

### DESCRIPTION OF EMBODIMENTS

Hereinafter, an etching agent, an etching method, and a method for producing a device according to the present disclosure will be described in detail based on an embodiment shown in the accompanying drawings.

### 1. Method for Producing Device

First, a method for producing a device according to an embodiment will be described.

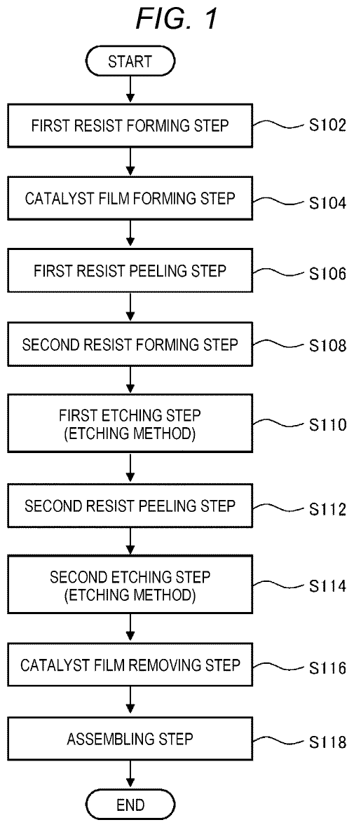

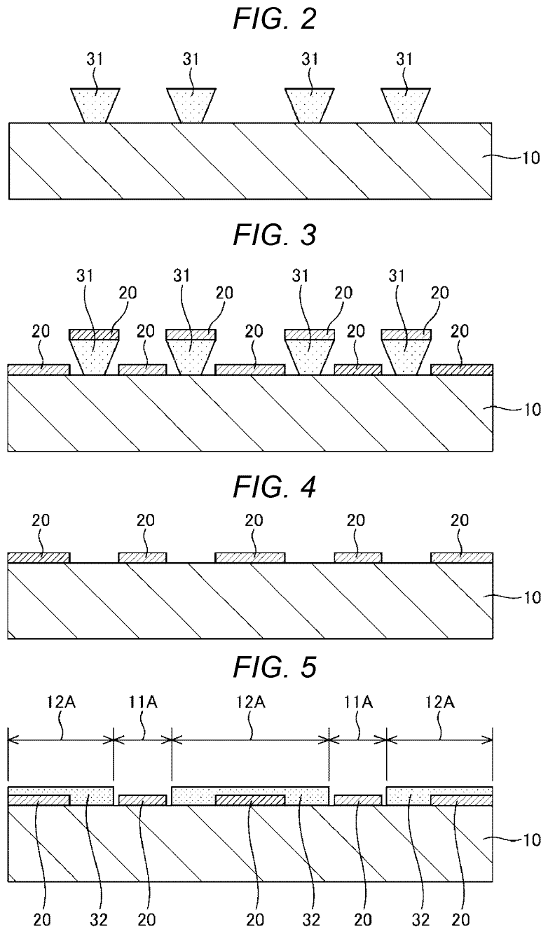

FIG. 1 is a process diagram showing a configuration of a method for producing a device according to an embodiment. FIGS. 2 to 9 are cross-sectional views illustrating the method for producing the device shown in FIG. 1.

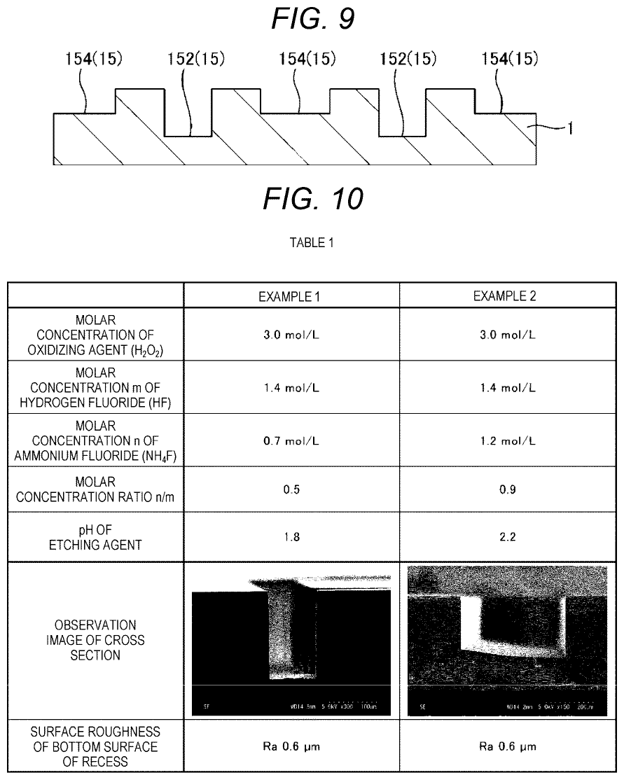

The method for producing the device shown in FIG. 1 includes a first resist forming step S102, a catalyst film forming step S104, a first resist peeling step S106, a second resist forming step S108, a first etching step S110, a second resist peeling step S112, a second etching step S114, a catalyst film removing step S116, and an assembling step S118. In such a method for producing a device, a surface of the semiconductor substrate 10 shown in FIG. 2 is etched to form recesses 15 shown in FIG. 9. Then, a device (not shown) is produced using a semiconductor substrate 1 (processed semiconductor substrate) in which the recess 15 is formed.

According to such a method for producing a device, compared with a method involving formation of a recess by dry etching, an environmental load is low and productivity is excellent.

In the first etching step S110 and the second etching step S114, metal-assisted chemical etching is performed on the semiconductor substrate 10 using an etching agent 9 (an etching agent according to the embodiment) described later. Accordingly, the recess 15 having a smooth bottom surface can be formed. As shown in FIG. 9, each of the recesses 15 to be formed in the embodiment includes, for example, two types of recesses 152 and 154 having different depths. The recess 152 is deeper than the recess 154.

### 1.1. First Resist Forming Step

In the first resist forming step S102, first, the semiconductor substrate 10 shown in FIG. 2 is prepared.

The semiconductor substrate 10 is made of a semiconductor material. Examples of the semiconductor material include group IV elements such as Si and Ge, compounds of group III elements and group V elements such as GaAs and GaN, and compounds containing group IV elements such as SiC. Here, the “group” is a “group” in the short-period periodic table.

Among these, a single crystal silicon substrate is preferably used for the semiconductor substrate 10, and a plane orientation (100) single crystal silicon substrate is more preferably used.

The semiconductor material may be doped with impurities. Further, elements such as a transistor, a diode, a resistor, and a capacitor may be formed at the surface of the semiconductor substrate 10.

When the semiconductor substrate 10 is a crystal substrate, the surface may be parallel to any crystal plane. In the present specification, the term “surface” refers to the surface of the semiconductor substrate 10 to be formed with the recess 15.

Next, as shown in FIG. 2, first resists 31 are formed at the surface of the semiconductor substrate 10. The first resists 31 are protective films that cover a part of the surface of the semiconductor substrate 10. As the first resist 31, a photoresist such as a photosensitive resin is preferably used, and a photoresist for lift-off is more preferably used. The photoresist for lift-off refers to a material capable of forming a coating having a reverse-tapered shape by patterning. Specifically, when the first resist 31 having a fine line shape is formed by patterning, the first resist 31 has an inverted trapezoidal cross-sectional shape as shown in FIG. 2. By using such a resist, in the first resist peeling step S106 described later, the first resists 31 and catalyst films 20 formed thereon can be smoothly lifted off. Therefore, the first resist 31 covers a range in which the catalyst film 20 is removed in a first resist peeling step S106 described later.

The first resist 31 is formed by applying a photosensitive resin, for example, and then patterning the same by photolithography.

### 1.2. Catalyst Film Forming Step

In the catalyst film forming step S104, as shown in FIG. 3, the catalyst films 20 are formed to cover the entire surface of the semiconductor substrate 10.

The catalyst film 20 contains noble metal serving as a catalyst in the metal-assisted chemical etching method. Examples of the noble metal include Au, Ag, Pt, Pd, Rd, Rh, and a combination thereof.

Examples of a method for forming the catalyst film 20 include various vapor phase film formation methods such as a sputtering method and a vapor deposition method. The catalyst film 20 may be formed by various liquid phase film formation methods, various plating methods, or the like.

The catalyst film 20 is preferably porous. Accordingly, permeation and replacement of the etching agent 9 in the first etching step S110 and the second etching step S114. Therefore, it is possible to achieve an improvement in an etching rate and an improvement in an etching depth, and thus, the work high in aspect ratio can be performed in a shorter time.

Examples of the method for forming the porous catalyst film 20 include a method for using a porous or particulate material, a method for stopping film formation before forming a continuous film to obtain a discontinuous film, and a method for making porous by patterning.

A thickness of the catalyst film 20 is not particularly limited, and is preferably about 3 nm or more and 100 nm or less, and more preferably about 10 nm or more and 30 nm or less. Accordingly, when the catalyst film 20 is porous, the permeation and the replacement of the etching agent 9 are more facilitated.

### 1.3. First Resist Peeling Step

In the first resist peeling step S106, the first resist 31 is peeled off. Accordingly, as shown in FIG. 4, the catalyst film 20 formed at the first resist 31 can be lifted off. At this time, when the first resist 31 has a reverse-tapered shape, the lift-off can be performed with high accuracy. By lifting off the catalyst film 20, the patterned catalyst film 20 is obtained as shown in FIG. 4.

### 1.4. Second Resist Forming Step

In the second resist forming step S108, first regions 11A where the catalyst films 20 are exposed and second regions 12A where the catalyst films 20 are not exposed are set with respect to the surface of the semiconductor substrate 10. That is, as shown in FIG. 5, the first regions 11A and the second regions 12A are set by covering a part of the catalyst films 20 with second resists 32.

Here, as an example, a portion to be finally formed with the deep recess 152 is set to the first region 11A, and other portions are set to the second region 12A. In the first region 11A, the catalyst film 20 containing the noble metal is covered and the catalyst film 20 is exposed. That is, it can be said that the noble metal is exposed in the first region 11A. On the other hand, the second region 12A shown in FIG. 5 is a portion where the catalyst film 20 containing the noble metal is not provided or the catalyst film 20 containing the noble metal is provided, but is not provided in an exposed state. That is, it can be said that the noble metal is not exposed in the second region 12A.

The second resist 32 is a protective film that selectively covers the second region 12A shown in FIG. 5. That is, the second resist 32 is a protective film having an opening corresponding to the first region 11A.

By setting the first region 11A and the second region 12A with respect to the semiconductor substrate 10, a catalytic action of the noble metal contained in the catalyst film 20 exposed in the first region 11A selectively acts in the first etching step S110 described later, and etching can be performed.

A resin resist is preferably used for the second resist 32. The resin resist is less likely to be eroded by the etching agent 9 used in the first etching step S110 described later. Therefore, the resin resist is more suitable for the second resist 32 than, for example, a resist using an inorganic material.

### 1.5. First Etching Step

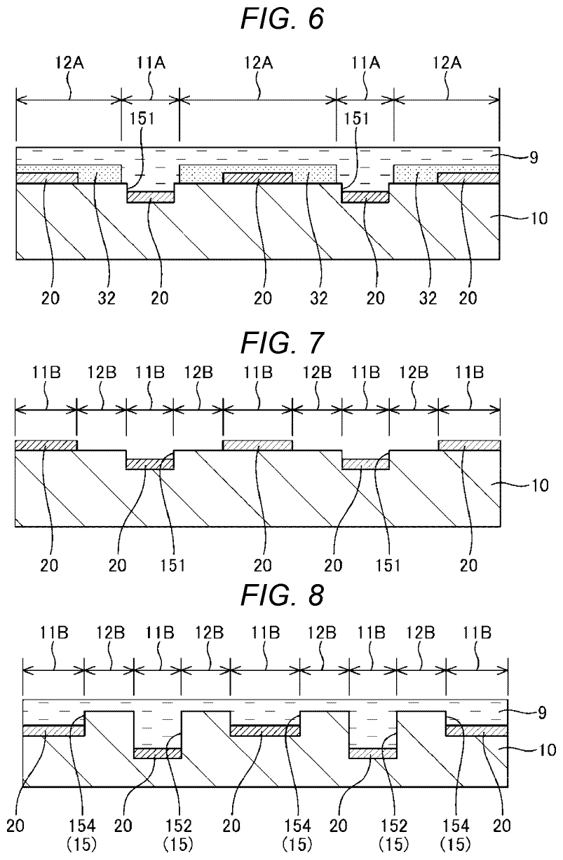

In the first etching step S110, the etching agent 9 (the etching agent according to the embodiment) shown in FIG. 6 is supplied to the surface of the semiconductor substrate 10 having the first region 11A and the second region 12A to etch the semiconductor substrate 10. Accordingly, as shown in FIG. 6, the recesses 151 are formed in the first region 11A.

In the first etching step S110, the metal-assisted chemical etching is used in which the etching agent 9 and the semiconductor substrate 10 are reacted using the noble metal contained in the catalyst film 20 as a catalyst. In the first region 11A, the semiconductor material close to the catalyst film 20 is oxidized, and an oxide thus generated is dissolved and removed. Accordingly, the first region 11A is selectively etched. The catalyst film 20 after being used for etching does not change chemically but moves toward the inside of the recess 151 of the semiconductor substrate 10 formed by etching. Then, movement and etching of the catalyst film 20 are repeated. As a result, the first region 11A is anisotropically etched in a thickness direction of the semiconductor substrate 10 to form the recess 151.

The etching agent 9 contains an oxidizing agent, hydrogen fluoride, and ammonium fluoride. When m is a molar concentration [mol/L] of hydrogen fluoride in the etching agent 9 and n is a molar concentration [mol/L] of ammonium fluoride, a molar concentration ratio n/m of the etching agent 9 satisfies 0.5≤n/m≤5.0 as described later.

According to such a configuration, since the molar concentration of each component in the etching agent 9 is optimized, the recess 151 having a smooth bottom surface can be formed. In the embodiment, the recess 151 is further etched in a step to be described later, and finally, the recess 15 having a smooth bottom surface and a target depth can be formed.

Examples of the oxidizing agent include H₂O₂ (hydrogen peroxide), HNO₃ (nitric acid), AgNO₃, KAuCl₄, HAuCl₄, K₂PtCl₆, H₂PtCl₆, Fe(NO₃)₃, Ni(NO₃)₂, Mg(NO₃)₂, Na₂S₂O₈, K₂S₂O₈, KMnO₄, and K₂Cr₂O₇, and one or more thereof are used. Among these, H₂O₂ is preferably used.

The molar concentration of the oxidizing agent in the etching agent 9 is not particularly limited, and is 0.01 mol/L or more, more preferably 0.1 mol/L or more and 8.0 mol/L or less, further preferably 0.5 mol/L or more and 5.0 mol/L or less, and particularly preferably 2.0 mol/L or more and 4.0 mol/L or less. When the molar concentration of the oxidizing agent is within the above range, a sufficient etching rate can be obtained while securing etching accuracy. When the molar concentration of the oxidizing agent is lower than a lower limit value, the etching rate may be insufficient. On the other hand, when the molar concentration of the oxidizing agent is more than an upper limit value, the etching accuracy may decrease.

The hydrogen fluoride generates hydrofluoric acid in the etching agent 9 and acts to dissolve the oxide generated by the oxidizing agent. The ammonium fluoride generates a complex of a semiconductor material in the etching agent 9 and acts to etch the semiconductor material in a small amount.

The molar concentration m [mol/L] of the hydrogen fluoride and the molar concentration n [mol/L] of the ammonium fluoride in the etching agent 9 satisfy 0.5≤n/m≤5.0 as described above. By setting the molar concentration ratio n/m of both within the above range, the recess 151 having a smooth bottom surface can be formed. When the molar concentration ratio n/m is less than the lower limit value, the smoothness decreases due to an uneven structure formed at the bottom surface of the recess 151 to be formed. In particular, when the catalyst film 20 is porous, for example, a needle-like uneven structure is likely to be formed. Such an uneven structure may hinder the use of the recess 151, and may drop off and become a foreign substance. On the other hand, when the molar concentration ratio n/m is more than the upper limit value, the etching rate decreases due to insufficient hydrogen fluoride and excessive ammonium fluoride.

The molar concentration ratio n/m preferably satisfies 0.6≤n/m≤3.0. Accordingly, it is possible to secure a stable etching rate regardless of other conditions while further enhancing the smoothness of the bottom surface of the recess 151.

The molar concentration ratio n/m more preferably satisfies 1.0≤n/m≤1.5. Accordingly, it is possible to secure a particularly favorable etching rate while further enhancing the smoothness of the bottom surface of the recess 151.

The etching rate can also be adjusted by a temperature of the etching agent 9, and for example, the etching rate can be increased by increasing the temperature of the etching agent 9. The temperature of the etching agent 9 is not particularly limited, and is preferably 20° C. or higher and 50° C. or lower.

The molar concentration m [mol/L] of the hydrogen fluoride preferably satisfies m≤2.0. Accordingly, it is possible to prevent side etching and enhancing etching accuracy while sufficiently securing an etching rate. When the molar concentration m is more than the upper limit value, the etching accuracy may decrease.

The molar concentration m of the hydrogen fluoride is more preferably 1.0≤m≤1.8. Accordingly, it is possible to further prevent the side etching and particularly enhance the etching accuracy while sufficiently securing the etching rate. When the molar concentration m is less than the lower limit value, the etching rate may slightly decrease. On the other hand, when the molar concentration m is more than the upper limit value, the etching accuracy may decrease.

The molar concentration n [mol/L] of the ammonium fluoride preferably satisfies n≤7.0. Accordingly, the generation of the uneven structure on the bottom surface of the recess 151 can be prevented, thereby obtaining the recess 151 having favorable smoothness of the bottom surface. When the molar concentration n is more than the upper limit value, the pH of the etching agent 9 may increase and the etching rate may decrease.

The molar concentration n of the ammonium fluoride is more preferably 0.8≤n≤4.5. Accordingly, it is possible to particularly prevent the generation of the uneven structure on the bottom surface of the recess 151. When the molar concentration n is less than the lower limit value, the smoothness of the bottom surface of the recess 151 may decrease. On the other hand, when the molar concentration n is more than the upper limit value, the pH of the etching agent 9 may increase, and the etching rate may slightly decrease.

The pH of the etching agent 9 is preferably 1.8 or more and 4.0 or less, more preferably 1.9 or more and 3.0 or less, and further preferably 2.0 or more and 2.4 or less. Accordingly, it is possible to sufficiently enhance the smoothness of the bottom surface of the recess 151 to be formed while securing a particularly sufficient etching rate.

The etching agent 9 may contain an additive other than the above-described components. Examples of the additive include an alcohol, a carboxylic acid, a hydroxy acid, an amine, an amino acid, a thiol, an organic fluorine compound, and a chelating reagent. A concentration of the additive in the etching agent 9 is preferably 0.001 mass % or more and 5 mass % or less, and more preferably 0.01 mass % or more and 1 mass % or less in total of the respective components.

A surface roughness (arithmetic average roughness Ra) of the bottom surface of the recess 151 to be formed is preferably 3.0 μm or less, more preferably 2.0 μm or less, and further preferably 1.0 μm or less. Accordingly, the recess 151 having particularly favorable smoothness of the bottom surface can be obtained.

The surface roughness is measured as follows. First, a cross section of the recess 151 is observed with a scanning electron microscope to obtain an observation image. Next, a contour of the bottom surface is identified in the observation image. Then, the arithmetic average roughness Ra of the contour is calculated by image processing.

### 1.5. Second Resist Peeling Step

In the second resist peeling step S112, the second resist 32 is peeled off. Accordingly, as shown in FIG. 7, the catalyst film 20 covered with the second resist 32 is exposed. Accordingly, a first region 11B where the catalyst film 20 is exposed and a second region 12B where the catalyst film 20 is not provided (not exposed) are formed at the surface of the semiconductor substrate 10 after the second resist peeling step S112.

In the first region 11B, the noble metal is exposed because the catalyst film 20 containing the noble metal is exposed. On the other hand, in the second region 12B, the noble metal is not exposed because the catalyst film 20 containing the noble metal is not provided.

By setting the first region 11B and the second region 12B with respect to the semiconductor substrate 10, the catalytic action of the noble metal exposed in the first region 11B selectively acts in the second etching step S114 described later, and etching can be performed.

### 1.6. Second Etching Step

In the second etching step S114, the etching agent 9 (the etching agent according to the embodiment) shown in FIG. 8 is supplied to the surface of the semiconductor substrate 10 having the first region 11B and the second region 12B to etch the semiconductor substrate 10. Accordingly, the recess 151 shown in FIG. 7 is further dug down, and the recess 152 shown in FIG. 8 is obtained. The portion where the recess 151 is not formed is also selectively etched to form the recess 154.

In the second etching step S114 as well, the recesses 152 and 154 having smooth bottom surfaces can be formed by performing the metal-assisted chemical etching using the etching agent 9 (the etching agent according to the embodiment).

### 1.7. Catalyst Film Removing Step

In the catalyst film removing step S116, the catalyst film 20 is removed. For the removal of the catalyst film 20, for example, a solution dissolving a noble metal is used. Accordingly, the semiconductor substrate 1 having the recess 15 shown in FIG. 9 is obtained.

### 1.8. Assembling Step

In the assembling step S118, a device (not shown) is produced using the semiconductor substrate 1 (processed semiconductor substrate) in which the recess 15 is formed. Since the bottom surface of the recess 15 is smooth, the semiconductor substrate 1 in which the recess 15 is formed is useful as a component having a cavity for accommodating, for example, an element. Therefore, according to the method for producing a device according to the embodiment, it is possible to efficiently produce a device having high shape accuracy while reducing an environmental load. Examples of the element accommodated in the cavity include a micro electro mechanical systems (MEMS) element, a vibration element, a sensor element, a light emitting element, and a light receiving element.

### 2. Etching Method

Next, the etching method according to the above-described embodiment will be described again.

In the first etching step S110 and the second etching step S114 of the method for producing the device shown in FIG. 1, an etching method is used in each embodiment.

In the first etching step S110, after the semiconductor substrate 10 having the first region 11A and the second region 12A is prepared on the surface, the etching agent 9 (the etching agent according to the embodiment) is supplied to the surface of the semiconductor substrate 10, and the semiconductor substrate 10 is etched. In the first region 11A shown in FIG. 5, the noble metal is exposed, and in the second region 12A, the noble metal is not exposed. Therefore, as shown in FIG. 6, the recess 151 in which the first region 11A is selectively etched is obtained.

The molar concentration ratio n/m of the etching agent 9 is optimized. Therefore, the bottom surface of the recess 151 formed in the semiconductor substrate 10 can be smoothed.

In the second etching step S114, after the semiconductor substrate 10 having the first region 11B and the second region 12B is prepared on the surface, the etching agent 9 (the etching agent according to the embodiment) is supplied to the surface of the semiconductor substrate 10, and the semiconductor substrate 10 is etched. In the first region 11B shown in FIG. 7, the noble metal is exposed, and in the second region 12B, the noble metal is not exposed. Therefore, as shown in FIG. 8, the recesses 152 and 154 in which the first region 11B is selectively etched are obtained.

The molar concentration ratio n/m of the etching agent 9 is optimized. Therefore, the bottom surfaces of the recesses 152 and 154 formed in the semiconductor substrate 10 can be smoothed.

### 3. Effects of Embodiment

As described above, the etching agent 9 according to the embodiment is an etching agent that performs etching on the semiconductor substrate 10 in which a part of the surface is covered with a noble metal, and includes an oxidizing agent, hydrogen fluoride, and ammonium fluoride. When m is a molar concentration [mol/L] of the hydrogen fluoride in the etching agent 9, and n is a molar concentration [mol/L] of the ammonium fluoride, the etching agent 9 satisfies 0.5≤n/m≤5.0.

According to such a configuration, in the metal-assisted chemical etching method, the etching agent 9 capable of forming a recess having a smooth bottom surface is obtained.

The etching agent 9 according to the embodiment preferably satisfies 0.6≤n/m≤3.0.

According to such a configuration, it is possible to secure a stable etching rate regardless of other conditions while further enhancing the smoothness of the bottom surface of the recess.

The etching agent 9 according to the embodiment preferably satisfies 1.0≤n/m≤1.5.

According to such a configuration, it is possible to secure a particularly favorable etching rate while further enhancing the smoothness of the bottom surface of the recess.

The etching agent 9 according to the embodiment preferably satisfies n≤7.0.

According to such a configuration, the generation of the uneven structure on the bottom surface of the recess can be prevented, thereby obtaining the recess having favorable smoothness of the bottom surface.

The etching agent 9 according to the embodiment preferably satisfies 0.8≤n≤4.5.

According to such a configuration, it is possible to particularly prevent the generation of the uneven structure on the bottom surface of the recess.

The etching agent 9 according to the embodiment preferably satisfies m≤2.0.

According to such a configuration, it is possible to prevent side etching and enhance etching accuracy while sufficiently securing an etching rate.

The etching agent 9 according to the embodiment preferably satisfies 1.0≤m≤1.8.

According to such a configuration, it is possible to further prevent the side etching and particularly enhance etching accuracy while sufficiently securing an etching rate.

An etching method according to the embodiment is a method for etching the semiconductor substrate 10, including preparing, on the surface, the semiconductor substrate 10 having the first regions 11A and 11B in which the noble metal is exposed and the second regions 12A and 12B in which the noble metal is not exposed, and supplying the etching agent 9 according to the embodiment to the surface of the semiconductor substrate 10 to etch the semiconductor substrate 10.

According to such a configuration, in the metal-assisted chemical etching method, a recess having a smooth bottom surface can be formed.

In the etching method according to the embodiment, the second regions 12A and 12B when etching is performed may be covered with a resin resist.

According to such a configuration, since the resin resist is less likely to be eroded by the etching agent 9, the resin resist is more suitable for covering the second regions 12A and 12B than a resist using an inorganic material, for example.

A method for producing a device according to the embodiment is a method for producing a device including a processed semiconductor substrate (the semiconductor substrate 1 in which the recess 15 is formed on a surface), the method including: forming the recess 15 in the surface of the semiconductor substrate 10 by the etching method according to the embodiment to acquire a processed semiconductor substrate; and producing the device using the processed semiconductor substrate.

According to such a configuration, the semiconductor substrate 1 (processed semiconductor substrate) in which the recess 15 having a smooth bottom surface is formed can be used as a component having a cavity for accommodating, for example, an element or the like. Therefore, a device having high shape accuracy can be efficiently produced while reducing an environmental load.

In the method for producing a device according to the embodiment, the second regions 12A and 12B when etching is performed may be covered with a resin resist.

According to such a configuration, since the resin resist is less likely to be eroded by the etching agent 9, the resin resist is more suitable for covering the second regions 12A and 12B than a resist using an inorganic material, for example.

Although the etching agent, the etching method, and the method for producing a device according to the present disclosure are described based on the shown embodiments, the present disclosure is not limited thereto.

For example, the etching agent according to the present disclosure may be obtained by adding any component to the above-described embodiment. In the etching method and the method for producing a device according to the present disclosure, any desired step may be added to the embodiment.

### EXAMPLES

Next, specific examples of the present disclosure will be described.

### 4. Preparation of Evaluation Sample

### 4.1. Examples 1 to 4

First, a silicon substrate having a conductivity type of P type and plane orientation (100) was prepared.

Next, a patterned catalyst film having a predetermined width was formed at a surface of the silicon substrate. A film thickness of the catalyst film was 16 nm, and Au was used as the noble metal contained in the catalyst film.

Next, an etching agent was supplied to the silicon substrate on which the catalyst film was formed to perform metal-assisted chemical etching. Accordingly, a recess having a width of 0.1 mm to 0.5 mm and a depth of 0.1 mm to 0.2 mm was formed, and evaluation samples of Examples 1 to 4 were obtained. A temperature of the etching agent in each of Examples was 23° C.±1° C. However, the temperature of the etching agent is not limited to the range.

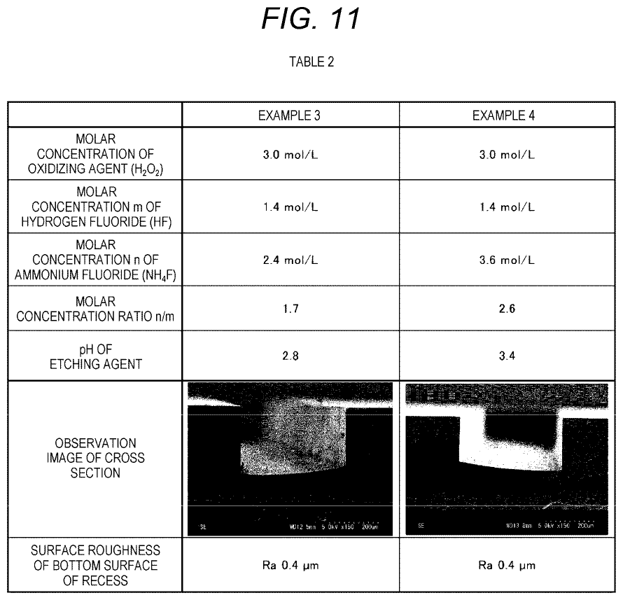

The molar concentration of the oxidizing agent, the molar concentration m of the hydrogen fluoride, the molar concentration n of the ammonium fluoride, the molar concentration ratio n/m, and the pH of the etching agent in the used etching agent are as shown in Table 1 (FIG. 10) and Table 2 (FIG. 11).

### 4.2. Comparative Example 1

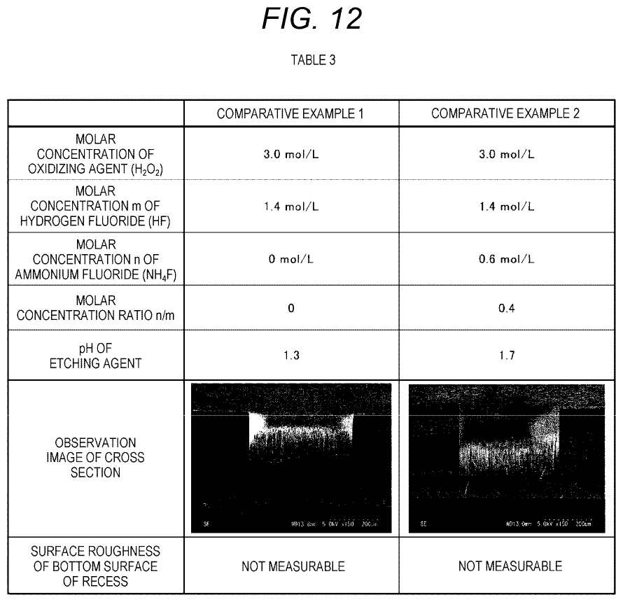

An evaluation sample was obtained in the same manner as in Example 1 except that the molar concentration n of ammonium fluoride in the used etching agent was set to zero. The pH of the etching agent is as shown in Table 3 (FIG. 12).

### 4.3. Comparative Example 2

An evaluation sample was obtained in the same manner as in Example 1 except that the molar concentration n of the ammonium fluoride in the used etching agent, the molar concentration ratio n/m, and the pH of the etching agent in the used etching agent were changed as shown in Table 3 (FIG. 12).

### 5. Evaluation of Evaluation Samples

### 5.1. Observation of Cross Section of Recess

The evaluation samples obtained in Examples and Comparative Examples were cut to intersect an extending direction of the recesses. Then, the obtained cross section was observed with a scanning electron microscope. Observation images are shown in Table 1 (FIG. 10), Table 2 (FIG. 11), and Table 3 (FIG. 12).

In the evaluation samples obtained in each of Examples, an uneven structure is not observed on the bottom surface of the recess and is smooth.

On the other hand, in the evaluation samples obtained in each of Comparative Examples, an uneven structure is observed on the bottom surface of the recess.

### 5.2. Surface Roughness of Bottom Surface of Recess

For the evaluation samples obtained in Examples and Comparative Examples, the arithmetic average roughness Ra of the bottom surfaces of the recesses was measured. Measurement results are shown in Table 1. For the evaluation samples obtained in the each of Comparative Examples, the surface roughness is not to be measured due to a significant influence of the uneven structure.

In the evaluation sample obtained in each of Examples, as shown in Table 1 (FIG. 10) and Table 2 (FIG. 11), it is found that the bottom surface of the recess is smooth. On the other hand, in the evaluation samples obtained in each of Comparative Examples, as shown in Table 3 (FIG. 12), an uneven structure is present on the bottom surface of the recess.

### 5.3. Etching Rate

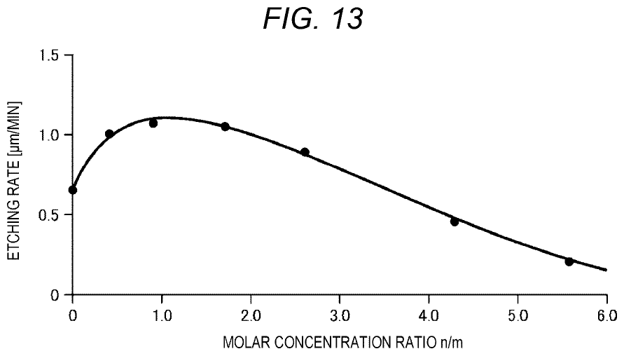

The etching rate when preparing the evaluation sample in each of Examples and each of Comparative Examples was calculated. The etching rate was calculated based on a depth of the recess and a required time. Calculation results are shown in FIG. 13. FIG. 13 is a graph showing a relationship between the molar concentration ratio n/m of the etching agent and the etching rate. In FIG. 13, a horizontal axis represents the molar concentration ratio n/m, and a vertical axis represents the etching rate [μm/minute] representing the depth [μm] of the recess formed by etching for one minute.

As shown in FIG. 13, when the molar concentration ratio n/m is 5.0 or less, a sufficient etching rate is obtained. In particular, when the molar concentration ratio n/m is 3.0 or less, the tendency is remarkable.

The molar concentration of the oxidizing agent was changed to 2.0 mol/L and 4.0 mol/L, and the same evaluation as described above was performed. As a result, the smoothness and the etching rate on the bottom surface of the recess show a tendency same as that when the molar concentration is 3.0 mol/L.

The molar concentration m of the hydrogen fluoride was changed to 1.0 mol/L and 1.8 mol/L, and the same evaluation as described above was performed. As a result, the smoothness and the etching rate on the bottom surface of the recess show a tendency same as that when the molar concentration is 1.4 mol/L.

What is claimed is:

1. An etching agent for etching a semiconductor substrate having a surface partially covered with a noble metal, the etching agent comprising:
an oxidizing agent;
hydrogen fluoride; and
ammonium fluoride, wherein
0.5≤n/m≤5.0, where
m is a molar concentration [mol/L] of the hydrogen fluoride, and
n is a molar concentration [mol/L] of the ammonium fluoride.

2. The etching agent according to claim 1, wherein
0.6≤n/m≤3.0.

3. The etching agent according to claim 2, wherein
1.0≤n/m≤1.5.

4. The etching agent according to claim 1, wherein
n≤7.0.

5. The etching agent according to claim 4, wherein
0.8≤n≤4.5.

6. The etching agent according to claim 1, wherein
m≤2.0.

7. The etching agent according to claim 6, wherein
1.0≤m≤1.8.

8. An etching method for etching a semiconductor substrate having, on a surface, a first region in which a noble metal is exposed and a second region in which the noble metal is not exposed, the method comprising:
supplying the etching agent according to claim 1 to the surface of the semiconductor substrate to etch the semiconductor substrate.

9. The etching method according to claim 8, wherein
the second region is covered with a resin resist when the etching is performed.

10. A method for producing a device, the method comprising:
forming a recess in the surface of the semiconductor substrate by the etching method according to claim 8.

11. The method for producing a device according to claim 10, wherein
the second region is covered with a resin resist when the etching is performed.
